(19) United States
(12) Patent Application Publication
(10) Pub. No.: US 2008/0010271 A1
(43) Pub. Date: Jan. 10, 2008

(54) METHODS FOR CHARACTERIZING THE CONTENT OF A WEB PAGE USING TEXTUAL ANALYSIS

(76) Inventor: Hugh C. Davis, Salem, UT (US)

Correspondence Address: MORRISS OBRYANT COMPAGNI, P.C., 734 EAST 200 SOUTH, SALT LAKE CITY, UT, 84102, US

(21) Appl. No.: 11/740,183

(22) Filed: Apr. 25, 2007

Related U.S. Application Data
(60) Provisional application No. 60/745,591, filed on Apr. 25, 2006.

(51) Int. Cl. G06F 17/30

(52) U.S. Cl. 707/5; 707/E17.105

(57) ABSTRACT

A method for decomposing textual contents of a web page using Search Tree technology, wherein binary search trees accelerate analysis of text to thereby determine if a word matches words and phrases which are associated with one or more categories of content, wherein scores are given to words using the first or the second method according to the degree of correlation to categories, and wherein a total score for any category exceeding a user selectable threshold assigns a web page to one or more categories, and wherein categories that are exceeded will cause an Internet filter to take an appropriate action, such as blocking access to or providing a warning when accessing a web page.

### CROSS-REFERENCE TO RELATED APPLICATION

This application claims the benefit of U.S. Provisional Application No. 60/745,591, filed Apr. 25, 2006, which is incorporated herein by reference in its entirety.

### TECHNICAL FIELD

This invention relates generally to analysis of text. More specifically, the present invention finds application in analyzing content of web pages accessible on the Internet, wherein the text that is displayed on a web page is analyzed to determine if the content should be displayed to a user in accordance with user selectable rules that define what content should be displayed.

### BACKGROUND

The present invention in its most basic form is dedicated to finding particular words and phrases written in a document that are also stored in a database. A particularly useful application of this ability is in Internet web content filtering. However, it should be remembered when reading this document that the principles of the present invention are applicable to applications beyond an Internet filter.

The ability to access millions of pages of information on the Internet has made on-line access a ubiquitous and indispensable part of life. Parents are now well aware that their children will fall behind their peers if they do not have the ability to look for information by using Internet search engines that catalog the vast landscape of web pages.

However, along with all of this wealth of information comes a large volume of content that is not suitable for children. But that content is disturbingly easy for a person of any age to access. A few key words entered into one of many search engines will make objectionable content literally one click away with a mouse button.

Accordingly, what is needed is a powerful yet simple method of analyzing the text content of a web page before it is displayed to a user on a computer screen. To that end, a market was created for programs known as Internet filters. Internet filters are designed to examine the content of a web page and take some pre-programmed action when objectionable content is found. Examples of some internet filters include those found in U.S. Pat. Nos. 5,382,212, 5,706,507, 5,987,606, 5,996,011, 6,266,664, 6,389,472, and 7,082,429, the disclosures of each of which are incorporated herein by reference in their entireties.

As these Internet filters have become more popular and eventually an indispensable tool for parents, several aspects of these tools have become important. These aspects include ease of installation, ease of use, accuracy in catching objectionable content, versatility in selecting what type of content is objectionable, and speediness of the program. Accordingly, it would be an advantage over the state of the art in Internet filters to provide a program that emphasizes all of these aspects, and provides a unique advantage in its methods of performing textual analysis of the content of web pages.

### SUMMARY

The present invention includes methods for decomposing textual contents of a web page using Search Tree technology, wherein binary search trees accelerate analysis of text to thereby determine if a word matches words and phrases which are associated with one or more categories of content, wherein scores are given to words according to the degree of correlation to categories, and wherein a total score for any category exceeding a user selectable threshold assigns a web page to one or more categories, and wherein categories that are exceeded will cause an Internet filter to take an appropriate action, such as blocking access to or providing a warning when accessing a web page.

These and other objects, features, advantages and alternative aspects of the present invention will become apparent to those skilled in the art from a consideration of the following detailed description taken in combination with the accompanying drawings.

### DESCRIPTION OF THE DRAWINGS

FIG. 1 is a box diagram illustrating one possible embodiment of a computer system for performing methods or processes in accordance with one aspect of the present invention.

FIG. 2 is a flowchart of one illustrative process for creating binary search trees in accordance with the present invention.

FIG. 3 is a flowchart of one illustrative process of processing an online document in accordance with the present invention

### DETAILED DESCRIPTION

Reference will now be made to the drawings in which the various elements of the present invention will be discussed so as to enable one skilled in the art to make and use the invention. It is to be understood that the following description is only exemplary of the principles of the present invention, and should not be viewed as narrowing the claims which follow.

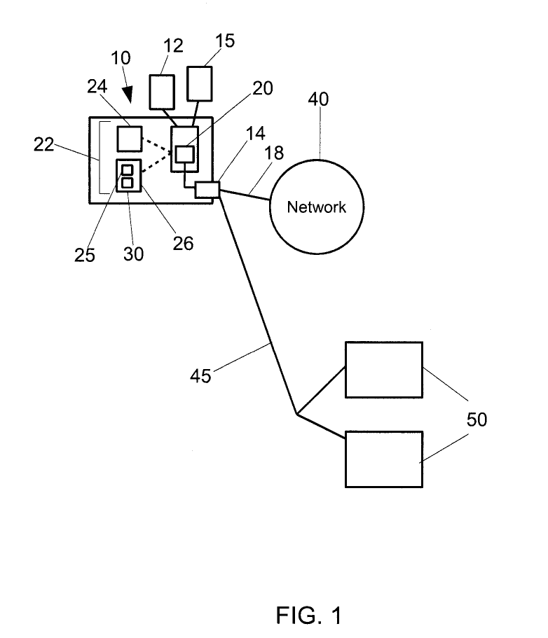

FIG. 1 depicts one possible embodiment of a computer system 10 for carrying out a portion of the methods and processes of the present invention. It will be appreciated that computer system 10 may be a single workstation or personal computer, with the methods and processes described herein acting in conjunction with a web browsing program operating thereon. In other embodiments, the computer system 10 may be a gateway computer, which includes or functions as a Web interfacing system (e.g., a Web server) for enabling access and interaction with other devices, such as one or more personal computers or workstations 50 linked therethrough to local and external communication networks (“networks”), including the World Wide Web (the “Internet”), a local area network (LAN), a wide area network (WAN), an intranet, the computer network of an online service, etc. Computer system 10 optionally may include one or more local displays 15, interface devices 12 and a network interface (I/O) 14 for bidirectional data communication through one or more and preferably all of the various networks (LAN, WAN, Internet, etc.) using communication paths or links known in the art, including wireless connections, ethernet, bus line, Fibre Channel, ATM, standard serial connections, and the like.

Still referring to FIG. 1, computer system 10 includes one or more microprocessors 20 responsible for controlling all aspects of the computer system. Thus, microprocessor 20 may be configured to process executable programs and/or communications protocols which are stored in memory 22. Microprocessor 20 may be provided with memory 22 in the form of RAM 24 and/or hard disk memory 26 and/or ROM (not shown). As used herein, memory designated for temporarily or permanently storing one or more content filtering protocols on hard disk memory 26 or another data storage device in communication with participant tracking computer system 10 may be referred to as a content filtering database 25, which may be configured in any suitable method known to those of ordinary skill in the art.

In one embodiment of the present invention, computer system 10 uses microprocessor 20 and the memory stored protocols to exchange data with other devices/users on one or more of the networks via Hyper Text Transfer Protocol (HTTP), although other protocols such as File Transfer Protocol (FTP), Simple Network Management Protocol (SNMP), and Gopher document protocol may also be supported. Computer system 10 may further be configured to send and receive HTML formatted files. In addition to being linked to a local area network (LAN) or a wide area network (WAN), computer system 10 may be linked directly to the Internet via network interface 14 and communication link 18 attached thereto. In embodiments where computer system 10 serves as a gateway, it may be linked to one or more workstations 50 via network interface 14 and communication link 45.

Computer system 10 will preferably contain executable software programs stored on hard disk 26. Alternatively, a separate hard disk, or other storage device 30, such as a removable flash drive, CD-ROM, floppy disk, or other removable media may optionally be provided with the requisite software programs for conducting the methods as described herein.

The methods of the present invention include textual analysis performed by analysis of words. It will be appreciated that the methods described herein may be accomplished by a computer, such as computer system 10 of FIG. 1, following a set of instructions contained as software code stored in a computer readable memory, such as the computer readable memory indicated at numerals 24, 26 or 30 of FIG. 1.

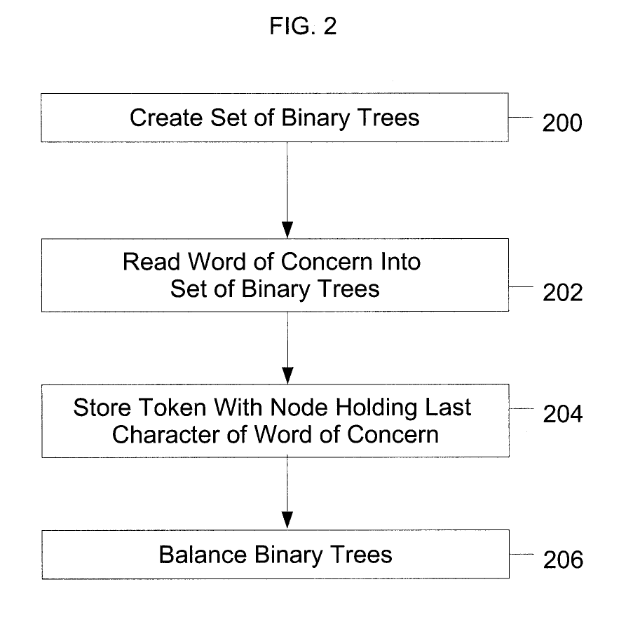

The first step may be to create binary trees, which may be accomplished along the lines described herein in conjunction with the flowchart depicted in the FIG. 2. The binary trees contain all words that are considered to be objectionable content. The construction of search trees may be as follows. Each unique word that is to be made part of the database of objectionable content is read in and parsed into a set of binary search trees, as depicted at box 202. The first character of a word is stored into a topmost tree. For each node in the tree, there is a set of conditional references to child binary search trees that hold the next character that follows in a given word. The next step is to then store the next character in the word into the appropriate child binary tree. The process is repeated for each letter in the word until the last letter in the word is stored in the binary search tree. A token for that word is then stored with the node holding the last character, as depicted at box 204.

It will be appreciated that the words used to create the binary trees may be selected to determine the category of content which is prevented from being displayed. For example, a list of words generated from accessing a known number of pornographic websites may be used to create binary trees for preventing exposure to pornography. Alternatively, words related to job hunting may be used for a corporate implementation, where employee attempts to use employer resources to seek new positions outside of the present employer is of concern. A complete list of objectionable content is not provided herein, as that list can be created according to the desires of the programmer. However, objectionable material is often associated with such topics as games, shopping, news, gambling, hate, violence, chat, adult, mature, lingerie, illegal activities, and personal ads.

It should be noted that longer words may go further down the binary tree than shorter words, and will thus have a different token stored in that particular node for their last character. Alternatively, there may be multiple tokens associated with a single word, if that word can be assigned in multiple categories.

It is noted that word misspellings may be included in a page being analyzed. These misspellings are sometimes intentional. Nevertheless, common misspellings may be included in the binary search tree in order to capture correct and incorrect spellings when appropriate.

The process for entering words is repeated until all words that will comprise the binary search trees have been entered. A final step is used to increase speed of a search. Specifically, the binary search trees can be balanced to ensure optimal performance by minimizing the expected search cost, as depicted at box 206. For example, the tree may be balanced based on expected word frequencies in downloaded web pages. More commonly used words may be placed nearer the root and less commonly used words may be placed near the leaves.

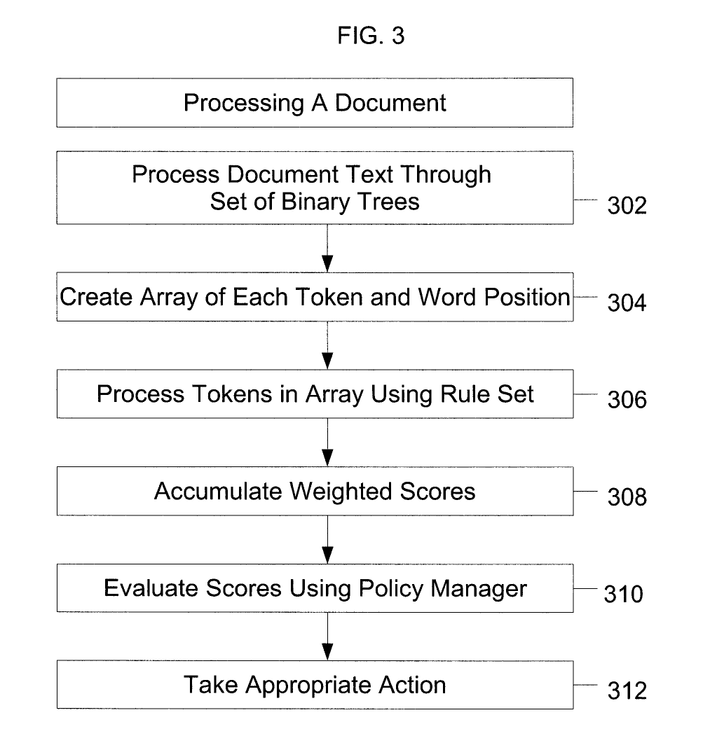

Once the binary search trees have been created, the next step is to process a document by performing a search, which may be accomplished along the lines described herein in conjunction with the flowchart depicted in the FIG. 3. In contrast to the pre-processing of words to generate word stems, or to generate lists of words as has been previously done with other content filtering methods, no such pre-processing is necessary when using binary search trees technology. It will be appreciated that the document to be processed may be any suitable document accessed using any suitable protocol, such as a web page accessed through a network such as an intranet or the internet using HTTP, an email accessed using SMTP, or otherwise. Accordingly, the document may even be a document that is local to a computer.

When processing a document, a counter is used to keep track of which word is being parsed. The document is processed through the binary search trees one character at a time, as depicted at box 302. Each character is processed against the topmost search tree, and for each matching node that is found, a marker is set. A matching node is defined as a word that ends in a node, and a token is found in that node.

If there are any markers that were previously set then the character is against the appropriate child search tree, and the mark is removed. New markers are set for matches that are found in the child search trees.

If any of the matching nodes at any level in the binary search tree has a token indicating a match to a word, then the token and its word position within the document are saved in an array, as depicted at box 304. The array is a list of token and position pairs. In other words, these are the tokens and the position of a word or words within the document that matched the node having that token.

Once all words within the document have been processed as described above, the next step is to process the tokens that are saved in the array, as depicted at box 306. The token/position pairs are processed using rules.

Each token has associated with it at least one rule, and possibly more. Each matching rule is checked to see if there is an associated weight or numerical score. If weights are associated with the rule, then the weight is added to the sum of weights being added for a particular category, as in the first embodiment. It is also possible that a rule may have a sub-rule associated with it. A sub-rule can also have an associated weight that is also added to the sum of weights for categories.

As for the rules themselves, a rule consists of a set of one or more words, the positional relationship between the words if there is more than one word in the rule, and the weights that are applied to one or more categories when the rule has been met. For example, if a word is correlated with a category of concern, such as a profane descriptor of a body part correlated with pornography, a weight can be applied. Where word position indicates that a phrase is being used that correlates with a category of concern, such as a phrase associated with pornography that includes a profane descriptor of a body part a second weight can be applied. Weights can be applied by summing weights or by applying another algorithm as may be desired.

For optimization in building the binary search trees, the set of unique words across all rules can be isolated and each word assigned a numerical token value.

As for sub-rules, any rule can be broken down into a primary rule and sub-rules if using more than one token, where the sub-rules define positional relationships between different rules. The final sub-rule at the end of each rule then has weights associated with it that are applied to the sum of weights being added for an appropriate category or categories.

The next step is to accumulate, for this one web page, all of the weighted scores for each category, as illustrated by box 308. After all words and phrases of the web page are processed by the method described above, the next step is to evaluate the total weighted scores for each category using a policy manager, as illustrated at box 310.

The policy manager enables desired actions to be taken depending upon the weighted scores that are collected for a web page. Typically any category that exceeds a threshold value will prompt an associated pre-programmed response by the Internet filter, as explained at box 312. This can be described as a policy-category-action linkage. For example, a user may be blocked from viewing a web page, a user may be warned that the page may contain inappropriate content, or the user may be allowed to view the page without warnings. This list of actions should not be considered limiting, but only as a sample of actions.

It should be noted that the threshold for each category is a user selectable value. Thus, the present invention enables the user to assign a degree of relevance to any particular category and thus to any particular weighted score. In other words, the present invention enables the sensitivity of the program to particular categories to be adjusted to a desired level of relevance.

It will be appreciated that web pages being accessed do not have to be on the Internet. In other words, some web pages may be stored on networks other than the Internet. Thus, the present invention may be useful for textual analysis in applications other than just Internet browsers, such as chat programs, instant messaging programs, etc.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for screening online documents for objectionable material, the method comprising:
creating a set of binary search trees by reading each word of a set of words associated with objectionable content into a set of binary search trees;
associating a token with each word of the set of words with the node of the binary search tree holding the last character of such word;
decomposing textual contents of an online document to determine if the online document contains words contained in the set of binary trees;
creating an array of the tokens located in the binary trees for words contained in the online document found in the binary trees;
processing the array in accordance with a set of rules; and
taking appropriate action based upon the array processing.

2. The method according to claim 1, wherein creating a set of binary search trees by reading each word of a set of words associated with objectionable content into a set of binary search trees comprises creating a set of binary search trees by reading each word of a set of words associated with pornographic web pages.

3. The method according to claim 1, wherein creating a set of binary search trees by reading each word of a set of words associated with objectionable content into a set of binary search trees comprises creating a set of binary search trees by reading each word of a set of words associated with job hunting web pages.

4. The method according to claim 1, wherein decomposing textual contents of an online document to determine if the online document contains words contained in the set of binary trees comprises decomposing a web page available on the internet or an email sent using the internet.

5. The method according to claim 1, wherein creating an array of the tokens located in the binary trees for words contained in the online document found in the binary trees further comprises recording the position of each word contained in the online document found in the binary trees.

6. The method according to claim 5, wherein processing the array in accordance with a set of rules comprises examining the word positions of each word contained in the online document found in the binary trees to determine if objectionable phrases are found in the online document.

7. The method according to claim 1, wherein processing the array in accordance with a set of rules comprises creating an aggregate score from tokens in the array to determine a degree of correlation of the online document to an objectionable category.

8. The method according to claim 7, wherein taking appropriate action based upon the array processing comprises preventing access to the online document if the degree of correlation of the online document to an objectionable category ranks above a threshold associated with a user attempting to access the document.

9. The method according to claim 8, wherein an administrator can select the threshold associated with each user.

10. The method according to claim 7, wherein taking appropriate action based upon the array processing comprises providing a warning to a requesting user if the degree of correlation of the online document to an objectionable category ranks above a threshold associated with a user attempting to access the document.

11. The method according to claim 1, wherein taking appropriate action based upon the array processing comprises preventing access to the online document or providing a warning if the array processing indicates the online document contains objectionable content.

12. A method for decomposing textual contents of an online document to screen for objectionable material, the method comprising:
processing each word contained in the textual contents of the online document by character against a set of binary search trees containing words associated with at least one category of objectionable content;
creating an array of tokens located in the binary search trees for words contained in the online document found in the binary search trees;
processing the tokens in the array to determine a degree of correlation between the online document and the at least one category of objectionable content; and
taking appropriate action based upon the degree of correlation between the online document and the at least one category of objectionable content.

13. The method according to claim 12, wherein processing each word contained in the textual contents of the online document by character against a set of binary search trees containing words associated with at least one category of objectionable content comprises processing each word contained in the textual contents of the online document by character against a set of binary search trees containing a set of words associated with pornographic web pages.

14. The method according to claim 12, wherein processing each word contained in the textual contents of the online document by character against a set of binary search trees containing words associated with at least one category of objectionable content comprises processing each word contained in the textual contents of the online document by character against a set of binary search trees containing a set of words associated with job hunting web pages.

15. The method according to claim 12, further comprising counting each word contained in the textual contents of the online document to determine the position of each word.

16. The method according to claim 15, wherein creating an array of tokens located in the binary search trees for words contained in the online document found in the binary search trees comprises recording the position of each word contained in the online document found in the binary trees.

17. The method according to claim 16, wherein processing the tokens in the array to determine a degree of correlation between the online document and the at least one category of objectionable content comprises examining the word positions of each word contained in the online document found in the binary trees to determine if objectionable phrases are found in the online document.

18. The method according to claim 12, wherein processing the tokens in the array to determine a degree of correlation between the online document and the at least one category of objectionable content comprises creating an aggregate score from tokens in the array to determine a degree of correlation of the online document to the at least one category of objectionable content.

19. The method according to claim 12, wherein taking appropriate action based upon the degree of correlation between the online document and the at least one category of objectionable content comprises preventing access to the online document or providing a warning to a requesting user if the degree of correlation of the online document to the at least one category of objectionable content ranks above a threshold associated with the user attempting to access the document.

20. The method according to claim 19, wherein an administrator can select the threshold associated with each user.

21. The method according to claim 12, wherein processing each word contained in the textual contents of the online document by character against a set of binary search trees containing words associated with at least one category of objectionable content further comprises processing each word contained in the textual contents of the online document by character against a set of binary search trees containing a set of words associated with objectionable web pages, wherein the objectionable web pages are selected from the group of objectionable web pages comprising games, shopping, news, gambling, hate, violence, chat, adult, mature, lingerie, illegal activities, and personal ads.
